(19) United States
(12) Patent Application Publication
(10) Pub. No.: US 2023/0149801 A1
(43) Pub. Date: May 18, 2023

(54) GAMING KIT

(71) Applicant: NOGILI LTD, Givatam (IL)

(72) Inventor: ROY COOPERVASSER, GIVATAIM (IL)

(21) Appl. No.: 17/526,105

(22) Filed: Nov. 15, 2021

(51) Int. Cl. A63F 13/213; A63F 13/217

(52) U.S. Cl. CPC A63F 13/213; A63F 13/217

(57) ABSTRACT

A gaming kit, including a drawn sheet and an application, for running on a hand-held computer including a camera, where the application includes at least one task, and where the task and accomplishment thereof are applicable by aiming the camera to at least a first zone of the sheet, for indicating at least one drawing of the first zone.

### TECHNICAL FIELD

The invention relates to the field of games played by smartphones.

### BACKGROUND

Smartphone games conventionally are not related to specific items.

There is a long felt need to provide a smartphone game being related to bedding.

### SUMMARY

A gaming kit, including:
a drawn sheet; and
an application.

### BRIEF DESCRIPTION OF THE DRAWINGS

Embodiments, features, and aspects of the invention are described herein in conjunction with the following drawings:

FIG. 1 depicts a gaming kit according to one embodiment of the invention at a first session.

FIG. 2 depicts the gaming kit of FIG. 1 at a second session.

FIG. 3 depicts the gaming kit of FIG. 1 at a third session.

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

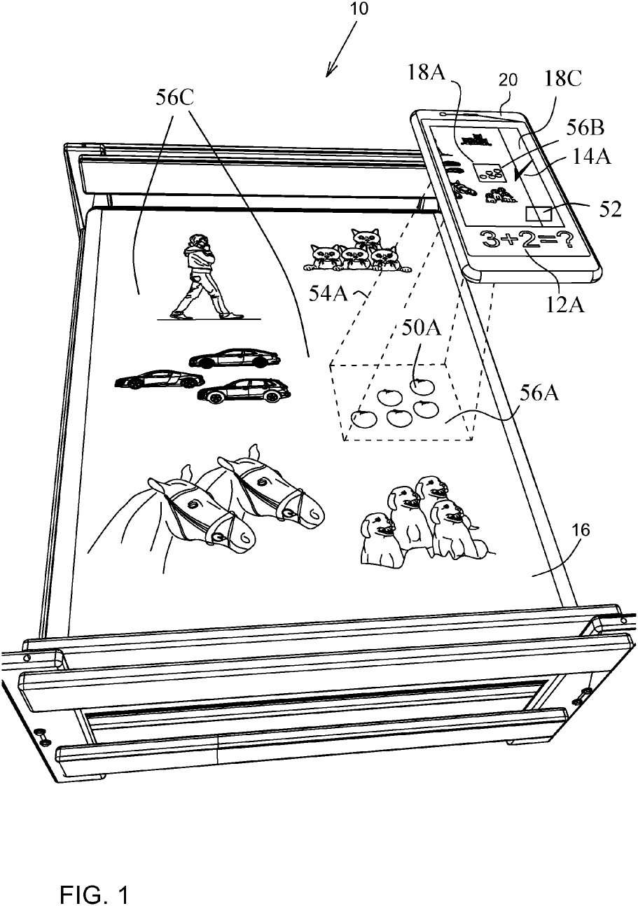

FIG. 1 depicts a gaming kit according to one embodiment of the invention at a first session.

A gaming kit 10 includes a sheet 16, such as a bed sheet, including drawings 50; and an application 52 running on a hand-held computer 20 including a camera, such as on a smartphone.

Upon running application 52, the application may raise a task 12A, such as a question of how much is 3 plus 2. The accomplishment of task 12A may be an answer of aiming (54) the camera of smartphone 20 on a zone 56A including a drawing 50A including 5 apples, being the answer of 5.

Application 52 may provide a simple response 14A approving the correct response.

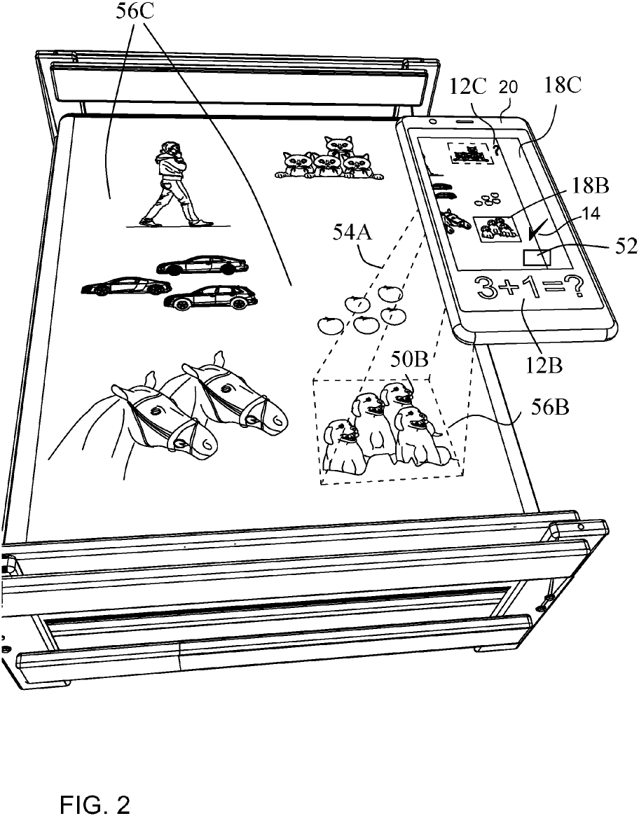

FIG. 2 depicts the gaming kit of FIG. 1 at a second session.

Then, application 52 may raise a question 12B, such as how much is 3 plus 1. The answer may be aiming (54) the camera of smartphone 20 on a zone 56B including a drawing 50B including 4 dogs, being the answer of 4.

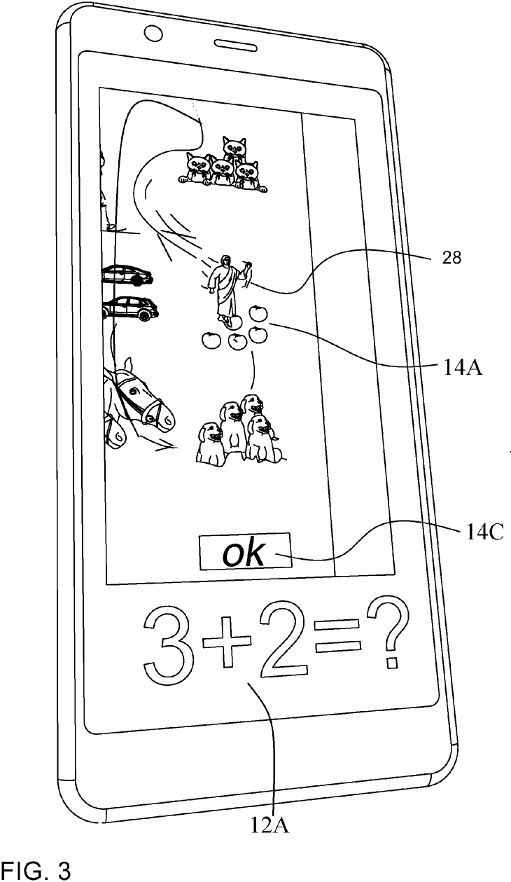

FIG. 3 depicts the gaming kit of FIG. 1 at a third session.

Then, application 52 may raise again question 12A, such as how much is 3 plus 2, and produce an animation of an image 28 popping-up from drawing 50B and wandering along a route 60 along drawings 50A, 50B, etc.

Image 28 displayed together with the displayed capturing of the sheet constitute augmented display.

Image 28 and the animation thereof may constitute another response 14B for approving the correct response.

Image 28 may further constitute different means for answering question 12A, being clicking once the image goes through drawing 14A including the 5 apples.

Image 28 may further constitute additional means for questioning, such as how many items are present on drawing 50A, displayed by its capture 18A, where image 28 is currently disposed, and the answer may be by clicking on the keyboard or vocalized.

Referring again to FIG. 2, captured zone 56B may be questioned, such as how many dogs, and the answer may be clicking “4” on the keyboard or other user interface of application 52.

Image 28 may enlarge or change its color upon encountering capture 18A of drawing 12A. This may raise additional questions and answers.

Thus, in one aspect, the invention is directed to a gaming kit (10), including:
a drawn sheet (16); and
an application (52), for running on a hand-held computer (20) including a camera,
wherein the application (52) includes at least one task (12A), and
wherein the task (12A) and accomplishment thereof
are applicable by aiming (54) the camera to at least a first zone (56A) of the sheet (16), for indicating at least one drawing (12A) of the first zone (56A).

The gaming kit (10) according to claim 1, wherein the task (12A) and accomplishment thereof are programmed according to the drawings (12A) of the drawn sheet (16).

The task (12A) and accomplishment thereof are further applicable by displaying on a screen (67) of the hand-held computer (20), a second zone (56C) of the sheet (16) including the first zone (56A), and being captured by the camera while being displayed.

The task (12A) and accomplishment thereof are further applicable by selecting the first zone (56A) from the second zone (56C).

The task (12A) and accomplishment thereof are further applicable by displaying on the screen (67) where the second zone (56C) is displayed, at least one image (28) not being captured by the camera while displayed, thereby the task (12A) and accomplishment thereof are applicable by considering an augmented display.

The displaying of image 28 and the route and other features thereof may be a function of encountering capture 18A of drawing 12A or other.

In the figures and/or description herein, the following reference numerals (Reference Signs List) have been mentioned:
numeral 10 denotes the gaming kit according to one embodiment of the invention;
12A,12B: tasks for the user;
14A, 14B, 14C: responses of application 52;
16: sheet;
18A,18B,18C: captures displayed by screen 67, of zones 56A, 56B and 56C respectively;
20: hand-held computer;
28: non-captured image;
50A,50B: drawings drawn on sheet 16;
52: application;
56A,56B: zones of sheet 16 being aimed by the camera;
56C: zone of sheet 16 being larger than zones 56A and 56B being captured by the camera and displayed by screen 67;
60: route of image 28;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A gaming kit, comprising:
a drawn sheet; and
an application, for running on a hand-held computer comprising a camera,
wherein said application comprises at least one task, and
wherein at least one
of said at least one task and
of accomplishment thereof
is applicable by aiming said camera to at least a first zone of said sheet, for indicating at least one drawing of said first zone.

2. The gaming kit according to claim 1, wherein
said at least one task and
said accomplishment thereof
are programmed according to said at least one drawing of said drawn sheet.

3. The gaming kit according to claim 1, wherein said at least one
of said at least one task and
of said accomplishment thereof
is further applicable by displaying on a screen of said hand-held computer, a second zone of said sheet comprising said at least said first zone, and being captured by said camera while being displayed.

4. The gaming kit according to claim 3, wherein said at least one
of said at least one task and
of said accomplishment thereof
is further applicable by selecting said at least first zone from said second zone.

5. The gaming kit according to claim 3, wherein said at least one
of said at least one task and
of said accomplishment thereof
is further applicable by displaying on said screen where said second zone is displayed, at least one image not being captured by said camera while displayed, thereby being applicable by considering an augmented display.

6. The gaming kit according to claim 5, wherein said at displaying of said least one image is a function of at least one member selected from a group including: said at least one task, said accomplishment thereof, encountering a capture of said at least one drawing.
